(19) United States
(12) Patent Application Publication
(10) Pub. No.: US 2005/0076141 A1
(43) Pub. Date: Apr. 7, 2005

(54) Use of an autoconfigured namespace for automatic protocol proxying

(76) Inventors: Aidan Michael Williams, Chifley (AU); Andrew White, Matraville (AU)

Correspondence Address: MOTOROLA, INC., 1303 EAST ALGONQUIN ROAD, IL01/3RD, SCHAUMBURG, IL, 60196, US

(21) Appl. No.: 10/666,406

(22) Filed: Sep. 19, 2003

(51) Int. Cl. G06F 15/16

(52) U.S. Cl. 709/245

(57) ABSTRACT

Methods and apparatuses for accessing, via a public network, a device connected to a privately addressed network are disclosed. One method comprises the steps of automatically assigning a globally unique name to the device, which resolves to a gateway of the privately addressed network, automatically associating the globally unique name with a private address of the device, and automatically routing communications comprising the globally unique name to the device based on the private address. The name and the address of the gateway may be registered with a Domain Name System (DNS) in response to a request received from the device. If a communication comprising the globally unique name is received for the device from another device via the Internet, a private address for the device dependent on the globally unique name may be automatically obtained for automatically routing the communication to the device.

### FIELD OF THE INVENTION

The present invention relates to communication networks and more particularly to privately addressed networks.

### BACKGROUND OF THE INVENTION

Users requiring a globally unique address space on the Internet are obliged to obtain such addresses from an Internet registry. However, the Internet Assigned Numbers Authority (IANA) has also reserved the following three blocks of the Internet Protocol version 4 (IPv4) address space for private networks:

| | |
|---|---|
| 10.0.0.0 | 10.255.255.255 (10/8 prefix) |
| 172.16.0.0 | 172.31.255.255 (172.16/12 prefix) |
| 192.168.0.0 | 192.168.255.255 (192.168/16 prefix) |

The first block comprises a single class A network number, the second block comprises a set of 16 contiguous class B network numbers, and the third block comprises a set of 256 contiguous class C network numbers. The foregoing three blocks of IP address space may be used without coordination by IANA or any other Internet registry and may thus result in the existence of globally ambiguous addresses. IP routing cannot be reliably performed under such circumstances.

Existing implementations of private networks employ Network Address Translation (NAT) at an Application Level Gateway (ALG) or a Residential Gateway, which translates globally unique network names to private addresses. Such translation can generally only be performed automatically when communications are routed from within a private network to a destination external to the private network (e.g., a host or device connected the Internet). Communications in the reverse direction, that is from a source device external to a private network to a destination device internal to the private network, require either manual configuration of the network address translation capability or a specialised signalling protocol.

FIG. 1 shows a networking environment 100 including privately addressed or home networks 110 and 120 both connected to the Internet 130 via residential gateways 115 and 125, respectively. Each of the residential gateways 115 and 125 include a network address translation (NAT) capability. Both the privately addressed networks 110 and 120 share the identical private address range, being 192.168.1.x. Hosts and/or devices connected to the privately addressed networks 110 and 120 can be uniquely identified by means of a value allocated to the x argument in the foregoing address range. However, such a value is only unique within the particular privately addressed network the value is allocated for and ambiguity can thus result if the same value is allocated to devices in both privately addressed networks.

Additionally, private address ranges are not intended to be routed on public networks, and many routers filter the private address ranges out. This is another reason private address ranges are not useful for public networks.

In the arrangement shown in FIG. 1, hosts or devices connected to the privately addressed networks 110 and 120 can access external hosts or devices such as those connected to the public Internet 130. The gateways 115 and 125 each include a network address translation (NAT) capability for mapping several private addresses of hosts or devices in privately addressed networks 110 and 120, respectively, to a single public address. If a device internal to one of privately addressed networks 110 and 120 initiates a connection to an external device, the NAT can configure a reverse mapping to the originating device. However, hosts or devices connected to one of the privately addressed networks 110 and 120 cannot access hosts or devices connected to the other of the privately addressed networks 110 and 120 without manual configuration or the use of a signalling protocol. Likewise, external devices cannot connect to hosts or devices in either of privately addressed networks 110 and 120. In other words, communications directed from devices or applications external to a privately addressed network to devices or hosts internal to the privately addressed network require manual configuration or a signalling protocol to resolve potential ambiguities with regard to private addressing and to set up incoming mappings to the correct internal host or device.

Disadvantageously, manual configuration requires skill and effort that is beyond the capability many users of privately addressed networks, particularly home networks. Furthermore, most existing Internet applications require modification to implement the signalling required to pass through network address translation (NAT) at the gateway of a privately addressed network.

### SUMMARY OF THE INVENTION

According to aspects of the present invention, there are provided a method and an apparatus for accessing, via a public network, a device connected to a privately addressed network. The method comprises the steps of automatically assigning a globally unique name to the device, which resolves to a gateway of the privately addressed network, automatically associating the globally unique name with a private address of the device, and automatically routing communications comprising the globally unique name to the device based on the private address. The public network may comprise the Internet and the foregoing steps may be performed by a network gateway device.

The method may comprise either or both of the further steps of automatically registering the globally unique name and an address of the gateway with a Domain Name System (DNS) and automatically extracting data relating to the globally unique name from Dynamic Host Configuration Protocol (DHCP) data.

The assigning step may be executed in response to a request from the device. The request may be received by a Dynamic Host Configuration Protocol (DHCP) server, which may provide an Internet Protocol (IP) address to said device.

The routing step may comprise the sub-steps of receiving a communication for the device from another device via the Internet, the communication comprising said globally unique name; automatically obtaining a private address for the device, the private address dependent on the globally unique name; and automatically routing the communication to the private address.

The apparatus embodies the method described herein and may comprise a network gateway device.

### BRIEF DESCRIPTION OF THE DRAWINGS

A small number of embodiments of the present invention are described hereinafter, by way of example only, with reference to the accompanying drawings in which:

FIG. 1 is a diagram of a networking environment;

FIG. 2 is a diagram of a gateway in a networking environment;

FIG. 3 is a flow diagram of a method for accessing a device connected to a privately addressed network via a public network;

FIGS. 4a and 4b are block diagrams showing additional detail of FIG. 2;

FIG. 5 is a flow diagram showing additional detail of FIG. 3;

FIG. 6 is a flow diagram showing additional detail of FIG. 3;

FIG. 7 is a block diagram of a home network with which embodiments of the present invention can be practised; and

FIG. 8 is a block diagram of the hardware architecture of a gateway with which embodiments of the present invention can be practised.

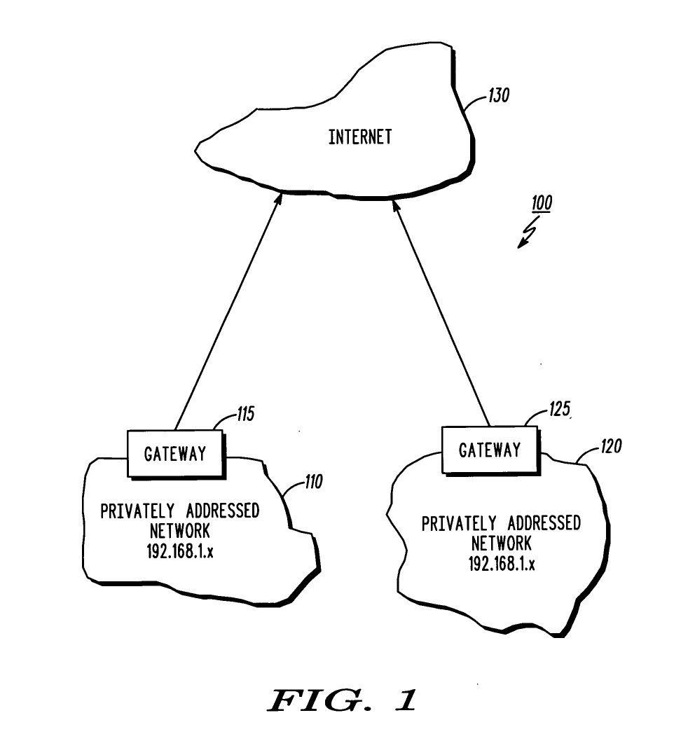

### DETAILED DESCRIPTION OF THE PREFERRED EMBODIMENT OF THE INVENTION

Methods and apparatuses for accessing a device connected to a privately addressed network via a public network are described hereinafter with reference to embodiments that include the Internet as a public network. However, the small number of embodiments described are not intended to be limiting in this regard since the principles described hereinafter have general applicability to other types of communication networks and network protocols. The embodiments have applicability to Internet Protocol version 4 (IPv4), which is limited to a 32-bit address space. However, the embodiments may also have applicability to Internet Protocol version 6 (IPv6), which has a 128-bit address space. Methods and apparatuses described hereinafter also relate to both enterprise and home private networks. Such networks include, but are not limited to, local area networks (LAN's), wireless networks, power-line networks and phone-line networks.

Some embodiments use Dynamic Host Configuration Protocol (DHCP) and Domain Name System (DNS) to achieve reverse proxying of the Hypertext Transfer Protocol (HTTP). DHCP is a protocol for assigning dynamic IP addresses on a network. Dynamic addressing enables a device to have different IP addresses assigned to the device, for example, each time that the device connects to a network. The DNS is a distributed Internet service that translates domain names into IP addresses. For example, the domain name ‘cube.aidan.eg.org’ might translate into the IP address 203.213.140.43. If a particular DNS server is unable to translate a particular domain name, the DNS server forwards the request to another DNS server. This process recurs until the domain name is resolved and returned to the original DNS server.

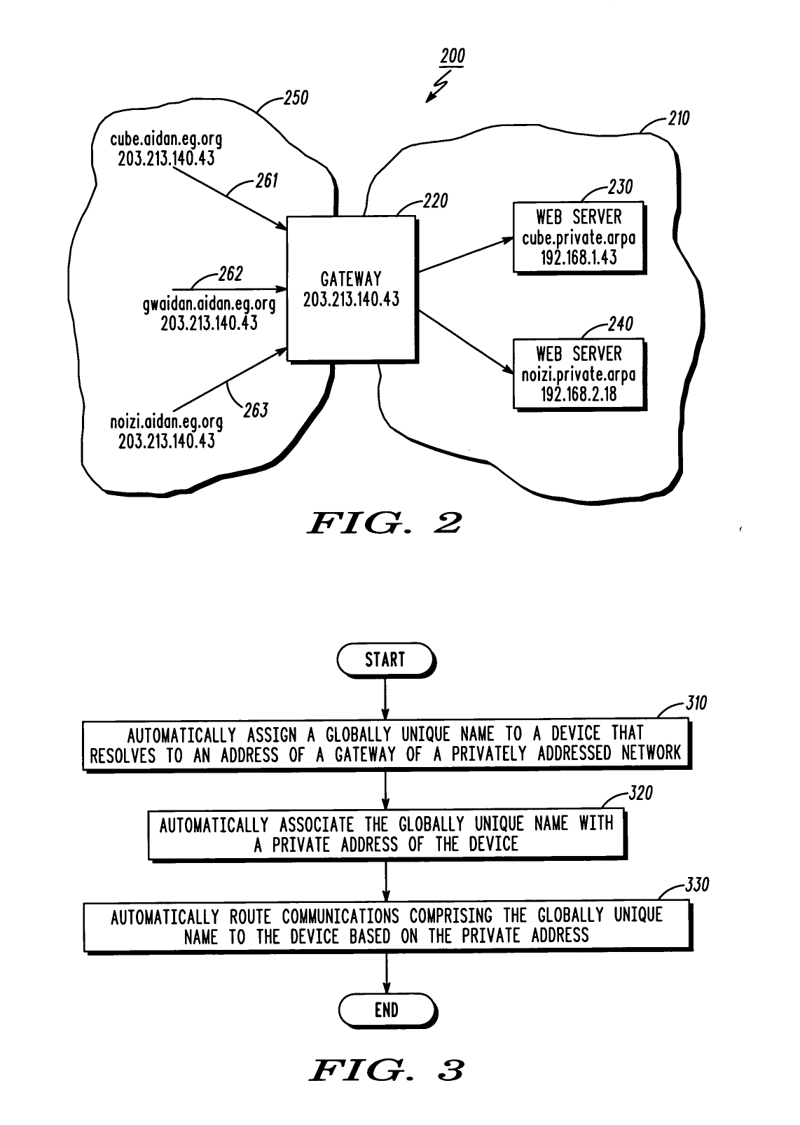

FIG. 2 shows a networking environment 200, which includes a privately addressed network 210 that has a gateway 220 through which web servers 230 and 240 can be connected to the Internet 250. The web servers 230 and 240 are depicted for illustrative purposes only and any number of hosts or devices (not necessarily web servers) may be connected to the privately addressed network, as would be well understood by a person skilled in the art. Furthermore, the networking environment 200 may comprise any number of privately addressed networks.

The globally unique IP address 203.213.140.43 resolves to the gateway 220. The internal IP addresses 192.168.1.43 and 192.168.2.18, both of which are within one of the blocks reserved by IANA for private network addressing, resolve internally to the web servers 230 and 240, respectively. The web servers 230 and 240 (‘cube’ and ‘noizi’, respectively) are added to the name of the privately addressed network (‘.private.arpa’) to produce names ‘cube.private.arpa’ and ‘noizi.private.arpa’, respectively. More generally, the names of devices or hosts connected to a privately addressed network are added to the privately addressed network's name to create internal names, which are translated into local addresses. While the IP addresses of the web servers 230 and 240 are unique within the privately addressed network 210, such addresses are ambiguous to, and/or hidden from, devices external to the privately addressed network 210 (e.g., devices connected to other privately addressed networks or the Internet 250). Additionally, if both of the web servers 230 and 240 offer web services on port 80 (the standard web server port), the gateway 220 has no way of knowing which of the web servers 230 and 240 a particular request should be forwarded to, or even if requests should be automatically forwarded.

Hosts or devices external to the privately addressed network 210 can communicate with the web servers 230 and 240 by sending requests 261, 262 and 263 to the gateway 220 that point or resolve to the global IPv4 address of the gateway 220 (i.e., 203.213.140.43). Each request 261, 262 and 263 comprise the name of the internal host or the web server that the request is directed to (e.g., ‘cube.aidan.eg.org’ and ‘noizi.aidan.eg.org’ for the web servers 230 and 240, respectively). An example of a request header relating to a request 261 from an external browser or a host directed to the internal webserver 230 is as follows:
GET/index.html HTTP/1.1
Host: cube.aidan.eg.org

The gateway 220 proxies such requests 261, 262 and 263 from an external host to the internal web servers 230 and 240 based on the name contained in the request header. In other words, the gateway 220 ‘demultiplexes’ requests directed to specific devices or hosts connected to the privately addressed network 210, based on the name contained in the request header. Although the foregoing description specifically relates to an externally generated request, the same principles apply to an externally generated response to a request generated by an internal host or device.

A proxy (in this case the gateway 220) accepts a connection on behalf of a device or host internal to a network (in this case the privately addressed network 210) and communicates with an external host or device making the connection. Additionally, the proxy opens a connection to the relevant internal device and communicates with that device. A proxy is thus a go-between for two communicating devices.

FIG. 3 is a flow diagram of a method for accessing a device connected to a privately addressed network via a public network.

At step 310, a globally unique name is automatically assigned to an internal host/device in a privately addressed network. The globally unique name resolves to an address of a gateway of the privately addressed network.

At step 320, the globally unique name is automatically associated with a private address of the device.

At step 330, communications (e.g., requests and responses) comprising the globally unique name are automatically routed to the host/device in the privately addressed network based on the private address of the device.

An embodiment that uses Dynamic Host Configuration Protocol (DHCP) is described hereinafter. A DHCP server receives a request from an internal host/device that contains a hostname and provides the internal host/device with an IP address. To enable Virtual Hosting Reverse Proxy (VHRP) or reverse proxying, the hostname is mapped into a globally unique name pointing at the gateway and this name is stored in a DNS. Another mapping is created that associates the internal IP address with the external name. As an example with reference to the network environment shown in FIG. 2, the global hostname ‘cube.aidan.eg.org’ is mapped to the internal hostname ‘cube.private.arpa’. A DNS server is updated according to the mapping, for use in subsequent DNS name lookups for automatic proxying of communications between an external host and an internal host.

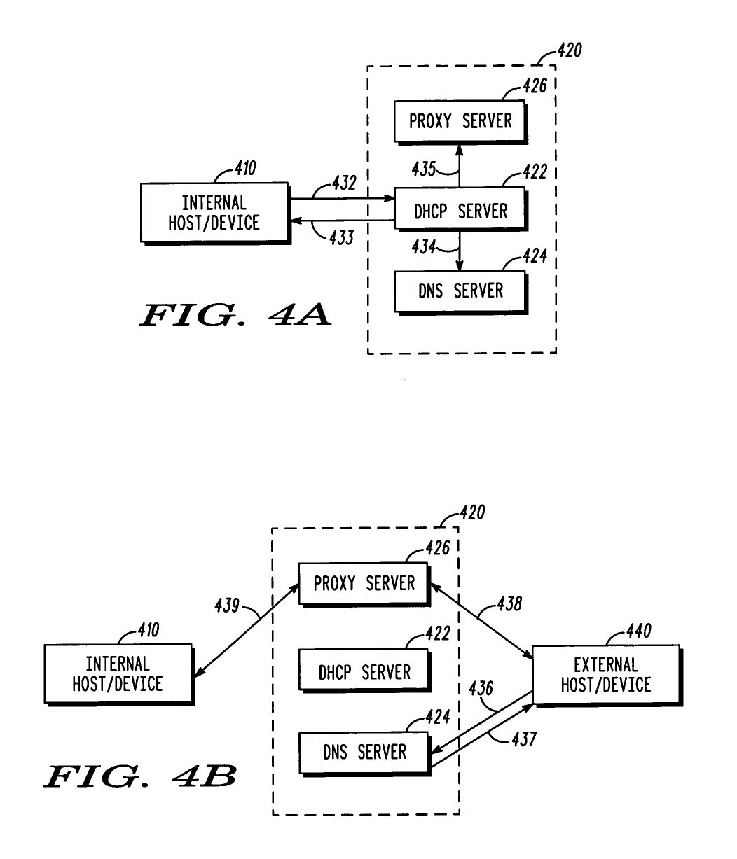

FIGS. 4a and 4b are block diagrams of a networking environment showing additional detail of the gateway 220 in FIG. 2. Specifically, the gateway 420 in FIGS. 4a and 4b corresponds to an embodiment of the gateway 220 in FIG. 2.

Referring to FIGS. 4a and 4b, a host/device 410 that is internal to a privately addressed network (not shown) is connected to a gateway 420 of the privately addressed network. The gateway 420 comprises a DHCP server 422, a DNS server 424, and a proxy server 426. The gateway 420 comprises separate computer systems to implement the functionality of the DHCP server 422, the DNS server 424, and the proxy server 426. As would be understood by persons skilled in the art, the functionality of the DHCP server 422, the DNS server 424, and the proxy server 426 can be implemented using software executing on one or more computer systems. Moreover, the DHCP server 422 and the DNS server 424 need not form part of the gateway 420. That is, either or both of the DHCP server 422 and the DNS server 424 can be located on a different device to the gateway 420.

Referring specifically to FIG. 4a, the internal host/device 410 sends a request to the DHCP server 422 for an Internet Protocol (IP) address (action 432). The requested address is forwarded to the internal host/device 410 by the DHCP server 422 (action 433) in response to the request. Thereafter, the DHCP server 422 installs the global name of the internal host/device 410 in the DNS server 422 (action 434) and associates this name with the address of the gateway 420. The DHCP server 422 also creates directly, or indirectly via an intermediate mechanism, mappings for the proxy server 426 to associate the private address of the internal host/device 410 with a global name of the internal host/device 410. Once the global name of the internal host/device 410 has been installed in the DNS server 424 and its associated distributed service and the mappings have been created for the proxy server 426, communications can occur between the internal host/device 410 and an external host/device via the gateway 420 as a proxy.

In one embodiment, an intermediate software program executing on the proxy server 426 extracts data from the DHCP lease file administered by the DHCP server 422, and registers the data with the DNS server 424. However, those skilled in the art would understand that numerous other embodiments to achieve the same result are possible. For example, the use of Dynamic DNS (DDNS), as described in RFC2136, enables a static hostname to be resolved to a dynamic IP address. Request For Comments (RFC) documents are official specification documents of the Internet Engineering Taskforce (IETF), which can be obtained from various websites and archives accessible via the Internet (e.g., http://www.ietf.org/internet-drafts/).

Referring specifically to FIG. 4b, an external host/device 440 forwards a request for the internal host/device 410 to the DNS server 424 (action 436). The DNS server 424 resolves the global address of the gateway 420 from the global name of the internal host/device 410 and returns the global gateway address to the internal host/device 410 (action 437). Thereafter, the external host/device 440 initiates a connection to the internal host/device 410 via the proxy server 426 (action 438) using the gateway address obtained in action 437. The proxy server 426 resolves the mapping between the global name and the private address of the internal host/device 410 and completes the connection to the internal host/device 410 (action 439).

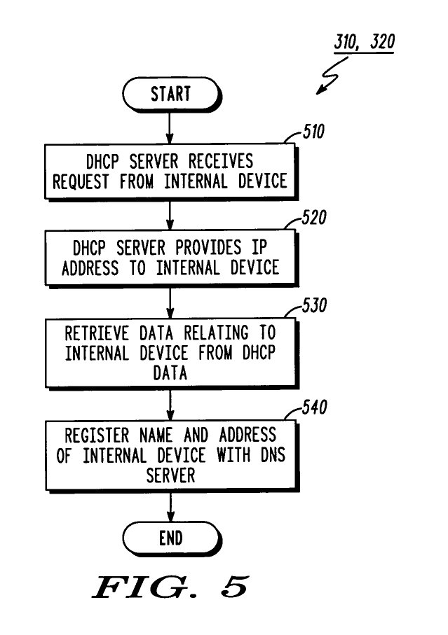

FIG. 5 is a flow diagram showing additional detail of steps 310 and 320 of FIG. 3. At step 510, a DHCP server receives a request from an internal host/device for an Internet Protocol (IP) address. The request comprises the private name of the internal host/device. At step 520, the DHCP server provides an IP address to the internal host/device. Data relating to the internal host/device is extracted from DHCP data (e.g., a DHCP lease file) at step 530 and the name and address of the internal host/device is registered with a DNS server and its associated distributed service at step 540. Separate hostname and address pairs are associated and registered for internal and external use as follows:
Internal: <hostname>.private.arpa=<address>
External: <hostname>.<external.network.name>=<gateway.address>

For illustration purposes only, an example of the association and registration of separate hostname and address pairs for internal and external use with reference to FIG. 2 is provided hereinafter. An internal host (web server) 230 provides its name (‘cube’) to the DCHP server. The DHCP server assigns the private address 192.168.1.43 to the internal host 230. The address 192.168.1.43 is associated with the name ‘cube.private.arpa’ for internal requests and the name ‘cube.aidan.eg.org’ is associated with the address 203.213.140.43 (the global address of the gateway 220) for external requests.

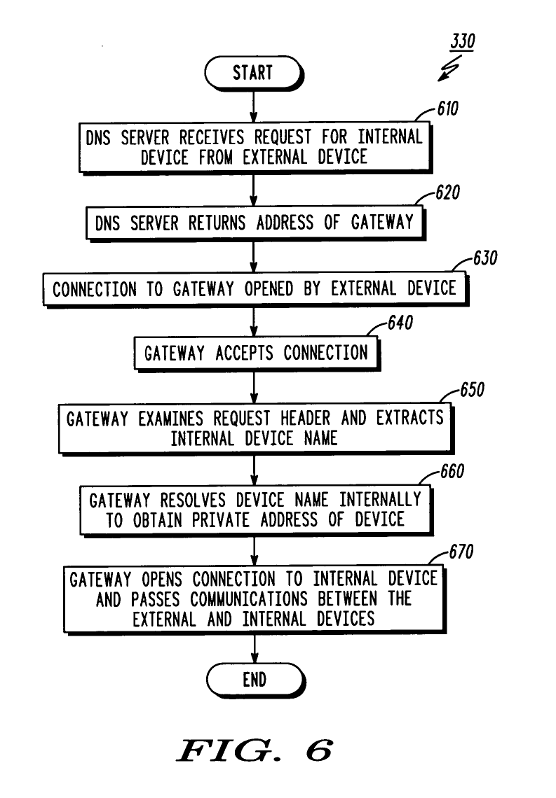

FIG. 6 is a flow diagram showing additional detail of step 330 of FIG. 3. At step 610, a request for an internal host/device is received by a DNS server from an external host/device. At step 620, the DNS server returns the address of a gateway, which is the gateway of a privately addressed network to which the internal host/device is connected, to the external host/device. At step 630, the external host/device opens a connection to the global gateway address 203.213.140.43 via port 80 (HTTP). At step 640, the gateway accepts the connection. At step 650, the gateway examines the request header that is directed to the internal host/device and extracts the internal hostname. The gateway resolves the hostname internally and obtains the internal host/devices's private address, at step 660. At step 670, the gateway opens a connection to the internal host/device and proxies communications between the external host/device and the internal host/device. The communications may be modified by the gateway.

As can be seen from the foregoing description, the DCHP server is involved in the initial registration and mapping process (i.e., step 310 of FIG. 3 and FIG. 4a), but does not otherwise participate in routing of communications between external and internal hosts (i.e., step 330 of FIG. 3 and FIG. 4b).

While FIG. 2 shows only two hosts (i.e., the web servers 230 and 240) connected to the privately addressed network 210, it will be readily appreciated by those skilled in the art that a privately addressed network may have any number of hosts or devices connected to the network.

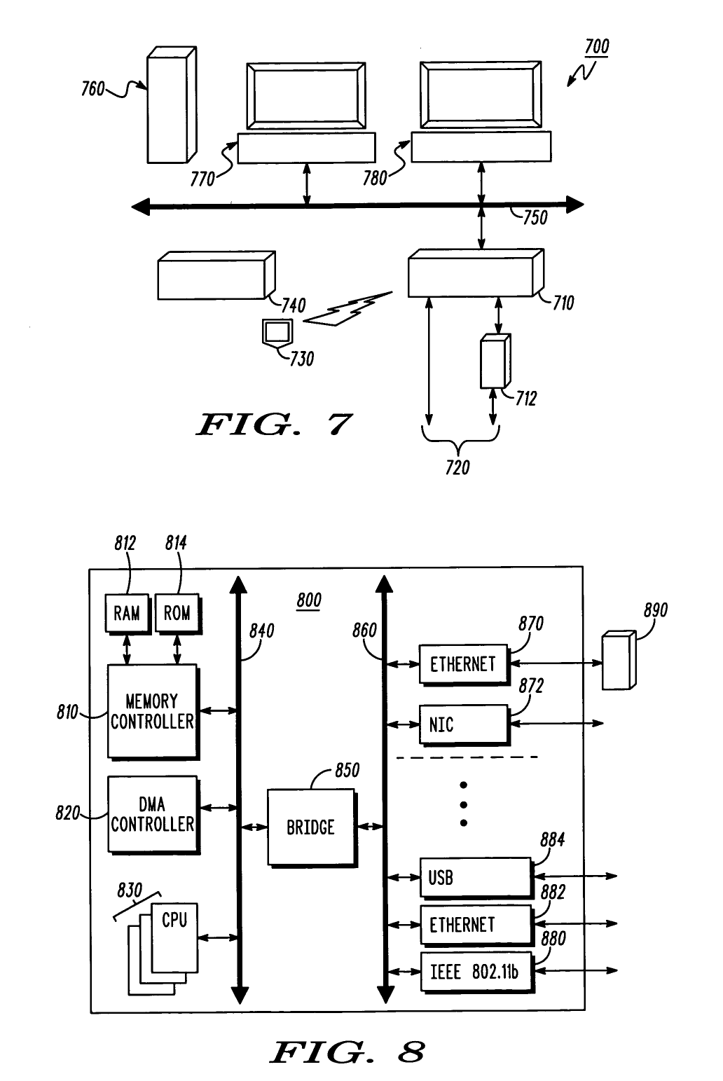

FIG. 7 is a block diagram of a privately addressed home network 700. The network 700 has a server 760 and two other computers 770 and 780 connected by an Ethernet network 750 to a residential gateway 710. The residential gateway 710 is also connected to a print server 740 and may be connected wirelessly to a PDA 730, for example. The gateway 710 may be connected by an appropriate communications interface directly, or by a modem 712 indirectly, to another remote home network or a public network such as the Internet, as indicated by connections 720. The foregoing is merely an example of the configuration of a home network and is not meant to be limiting to the embodiments of the invention.

FIG. 8 illustrates an example of a hardware architecture that may be used to implement the gateway 220 of FIG. 2 and the gateway 420 of FIG. 4.

FIG. 8 is a block diagram illustrating the architecture of a gateway 800 with which the embodiments of the invention may be practiced. The gateway 800 may comprise a residential gateway for use in home networks. The gateway 800 comprises one or more central processing units (CPUs) 830, a memory controller 810, and storage units 812, 814. The memory controller 810 is coupled to the storage units 812, 814, which may be random access memory (RAM), read-only memory (ROM), and any of a number of storage technologies well know to those skilled in the art. The CPU 830 and the memory controller 810 are coupled together by a processor bus 840. A direct-memory-access (DMA) controller 820 may also be coupled to the bus 840. The DMA controller 820 enables the transfer of data to and from memory directly, without interruption of the CPU 820. As shown in FIG. 8, the processor bus 840 serves as the memory bus, but it will be well understood by those skilled in the art that separate processor and memory buses may be practiced. Software to implement functionality of the gateway may be embedded in the storage unit, comprising an operating system, drivers, firmware, and applications. The CPU 830 functions as the processing unit of the gateway, however, other devices and components may be used to implement the processing unit.

A bridge 850 interfaces the processor bus 840 and a peripheral bus 860, which typically operates at lower data rates than the processor bus 840. Various interfaces are in turn coupled to the peripheral bus 860. For example, one or more of several ‘downlink’ communications interfaces may be practiced to connect devices in a privately addressed network to the gateway using a private addressing scheme and an associated naming scheme. The gateway 800 has as examples of such interfaces an IEEE 802.11b wireless interface 880, an Ethernet interface 882, and a Universal Serial Bus (USB) interface 884. The foregoing are merely examples and other network interfaces may be practiced, such as a Token Ring interface, other wireless LAN interfaces, and an IEEE 1394 (Firewire) interface. For connections external to a privately addressed network (e.g., to a global address via a public network such as the Internet), other ‘uplink’ network interfaces may be practiced. For example, the gateway 800 may have a network interface card 872 for connection to another network. Alternatively, the gateway 800 may comprise an Ethernet interface 870, which can be connected to a suitable modem 890 (e.g., a broadband modem). Still other network interfaces may be practiced including ATM and DSL, as examples of a few.

A protocol-specific proxy accepts connections via an ‘uplink’ interface, demultiplexes the connections based on a public hostname, and communicates with a device accessible via a ‘downlink’ interface on behalf of a device connected to the ‘uplink’ interface.

The methods for accessing a device or host connected to a privately addressed network via a public network may be implemented as software or computer programs carried out in conjunction with the processing unit and the storage unit(s) of the gateway. In certain embodiments, the translation of external names to internal addresses for use by a proxy is performed by a DNS server internal to the gateway that is automatically configured by DHCP in response to requests for registration of internal hosts. However, it would be readily appreciated by those skilled in the art that such translation can be performed externally to the gateway. Similarly, the translation of external names to the gateway's address for use by external hosts can be performed by a DNS server external to the gateway. This can be augmented by name registration triggered by an external DHCP request.

External name queries are directed to a name resolution mechanism or service external to the gateway. In an embodiment described hereinbefore, this is achieved by registering the gateway's domain name (e.g., ‘aidan.eg.org’) with an appropriate external DNS server.

While the gateway 800 has been depicted as a standalone device by itself, or in combination with a suitable modem, it will be well understood by those skilled in the art that the gateway may be implemented using a computer system with suitable software to implement the gateway functionality. Other variations may also exist. Specifically, the gateway 800 may be implemented as a discrete consumer device, which is configurable by a web interface attached to a privately addressed network. Hardware platforms such as those capable of performing the functions of a firewall or router can also be used to implement the methods described herein.

Advantageously, the methods and apparatuses described hereinbefore enable hosts and devices connected to privately addressed networks to be automatically exposed to hosts on the Internet. Thus, web and Session Initiation Protocol (SIP) servers located behind network address translation can be automatically accessed by hosts external to the privately addressed network. SIP is a signalling protocol for Internet conferencing, telephony, presence, event notification and instant messaging.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. It should be understood that various changes might be made in the function and arrangement of elements without departing from the spirit and scope of the invention as set forth in the appended claims.

1. A method for accessing, via a public network, a device connected to a privately addressed network, said method comprising the steps of:
automatically assigning a globally unique name in said public network to said device, wherein said name resolves to an address of a gateway of said privately addressed network;
automatically associating said globally unique name with a private address of said device; and
automatically routing communications comprising said globally unique name to said device based on said private address.

2. The method of claim 1, wherein each of said steps are performed without human intervention.

3. The method of claim 1, wherein said public network comprises the Internet.

4. The method of claim 1, wherein said steps are performed by said gateway.

5. The method of claim 3, comprising the further step of automatically registering said globally unique name and an address of said gateway with a Domain Name System (DNS).

6. The method of claim 5, comprising the further step of automatically extracting data relating to said globally unique name from Dynamic Host Configuration Protocol (DHCP) data.

7. The method of claim 6, wherein said assigning step is executed in response to a request from said device.

8. The method of claim 7, wherein said request is received by a Dynamic Host Configuration Protocol (DHCP) server and said method comprises the further step of said Dynamic Host Configuration Protocol (DHCP) server providing an Internet Protocol (IP) address to said device.

9. The method of claim 3, wherein said routing step comprises the sub-steps of:
receiving a communication for said device from another device via the Internet, said communication comprising said globally unique name;
automatically obtaining a private address for said device, said private address dependent on said globally unique name; and
automatically routing said communication to said private address.

10. The method of claim 9, wherein said sub-steps are performed by said gateway.

11. An apparatus for accessing, via a public network, a device connected to a privately addressed network, said device comprising:
at least one communications interface for transmitting and receiving data;
a storage unit for storing data and instructions to be performed by a processing unit; and
a processing unit coupled to said at least one communications interface and said storage unit, said processing unit programmed to:
automatically assign a globally unique name in said public network to said device, wherein said name resolves to an address of a gateway of said privately addressed network;
automatically associate said globally unique name with a private address of said device; and
automatically route communications comprising said globally unique name to said device based on said private address.

12. The apparatus of claim 11, wherein said processing unit is programmed to automatically route said communications to said device without human intervention.

13. The apparatus of claim 11, wherein said public network comprises the Internet.

14. The apparatus of claim 13, wherein said processing unit is further programmed to automatically register said globally unique name and an address of said gateway with a Domain Name System (DNS).

15. The apparatus of claim 14, wherein said apparatus comprises a network gateway device.

16. The apparatus of claim 14, wherein said processing unit is further programmed to automatically extract data relating to said name from Dynamic Host Configuration Protocol (DHCP) data.

17. The apparatus of claim 16, wherein said processing unit is further programmed to automatically assign said globally unique name to said device in response to a request from said device.

18. The apparatus of claim 17, wherein said processing unit is further programmed to automatically provide an Internet Protocol (IP) address to said device.

19. The apparatus of claim 13, wherein said processing unit is further programmed to:
automatically receive a communication for said device from another device via the Internet, said communication comprising said globally unique name;
automatically obtain a private address for said device, said private address dependent on said globally unique name; and
automatically route said communication to said private address.

20. The apparatus of claim 19, wherein said apparatus comprises a network gateway device.
